(19) United States
(12) Patent Application Publication
(10) Pub. No.: US 2025/0153443 A1
(43) Pub. Date: May 15, 2025

(54) SYSTEMS AND METHODS FOR MONITORING AND CONTROLLING ADDITIVE PRINTING PROCESSES

(71) Applicant: The Trustees of Indiana University, Bloomington, IN (US)

(72) Inventors: Ehsan Malekipour, Glassboro, NJ (US); Hazim A. El-Mounayri, Fishers, IN (US)

(21) Appl. No.: 18/927,321

(22) Filed: Oct. 25, 2024

Related U.S. Application Data
(60) Provisional application No. 63/599,136, filed on Nov. 15, 2023.

(51) Int. Cl. B29C 64/393; B29C 64/153; B33Y 10/00; B33Y 30/00; B33Y 50/02

(52) U.S. Cl. CPC B29C 64/393; B29C 64/153; B33Y 10/00; B33Y 30/00; B33Y 50/02

(57) ABSTRACT

Monitoring and control system and method for additive manufacturing an in-situ macro-field thermography that uses an IR camera or near-IR camera to prioritize the data captured from an entire print layer, processes data streams layer-by-layer, and provides thermal history of previously printed layers as feedback to the control system. The system leverages one or more different mathematical thermophysical-based (MTB) models to compute a thermally related specification in order to optimize the printing sequence of islands or stripes layer-by-layer. The thermal feedback from the thermography system calibrates or updates the thermal model layer-by-layer. The system and/or method may provide real-time optimization of scanning topology in chessboard and stripe printing strategies. The method may be implemented by one or more computer programs controlling one or more computer controllers of an additive manufacturing system, such as a 3D printer implementing a metal powder bed fusion additive manufacturing process.

### CROSS-REFERENCE TO RELATED APPLICATIONS

This application claims the benefit of U.S. Provisional Application No. 63/599,136 filed Nov. 15, 2023, the contents of which are incorporated herein by reference.

### BACKGROUND OF THE INVENTION

The invention generally relates to additive manufacturing and more particularly to systems and methods of monitoring and controlling additive manufacturing processes.

Additive manufacturing of objects using three-dimensional (3D) printing systems is useful for quickly making 3D objects having complex three-dimensional shapes. One frequently used process of additive manufacturing on a 3D printer is the powder bed fusion (PBF) process. In the powder bed fusion process, a computer-aided design (CAD) template or model is first created defining the geometric shape, and often other parameters, of the 3D object to be manufactured. Next, a powder form of print material, such as a metal, plastic, or ceramic material, is deposited on the print bed. Then, a thermal source, such as a laser beam, moves across the powder layer along a predetermined printing sequence, based on the CAD template. The thermal source fuses the powdered print material, for example by melting and/or sintering, turning the powdered print material into a solid. These steps are repeated for subsequent layers until the 3D object is formed by the accumulated layers.

The powder bed fusion process is increasingly employed by industry to fabricate complex parts with stringent standard criteria. However, fabricating parts “free of defects” using the PBF process is a challenge because, among other reasons, thermally induced abnormalities often form defects generated by the PBF process. Such thermal abnormalities may include, for example, warpage, delamination, cracks, and other types of defects in the structural integrity of the 3D object. These thermal abnormalities are typically the result of thermal evolution, that is, changing temperature over time and/or the development of temperature gradients between different areas/volumes of the deposited and fused print material. In order to minimize the development of thermal abnormalities, it is known that controlling the temperature and its distribution throughout a layer under fabrication to minimize temperature gradients temporally and/or spatially is an effective and efficient proxy to controlling the thermal evolution that primarily causes the thermal abnormalities. However, currently known methods for accomplishing this typically do not provide optimal solutions and/or take excessive amounts of time to calculate and therefore undesirably slow down the 3D printing process. Therefore, it would be desirable to have a system and/or method of implementing an additive manufacturing process based on thermally fusing print material that reduces and/or minimizes the formation of thermal gradients caused by the thermal evolution and can be implemented “in real time” without slowing down the additive manufacturing printing process, for example, as implemented on a 3D printer.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, a method of controlling an additive printing process implemented by a 3D printer, a system for monitoring and controlling a 3D printer, a 3D printing system, and a set of computer instructions configured to implement the method.

According to a nonlimiting aspect of the invention, a method is provided for controlling an additive printing process implemented by a 3D printer in manufacturing a 3D object from multiple layers of print material. The method includes printing a layer of print material across a print area according to a first print sequence of islands and/or stripes using a thermal fusion process, wherein the layer comprises a plurality of melt areas of the print material; obtaining temperature distribution information for the layer across the entire print area; calculating a second print sequence of islands and/or stripes based on the temperature distribution information for printing an immediately succeeding layer of print material on the layer, wherein the second print sequence is different than the first print sequence and is optimized based on the temperature distribution information to produce an optimal uniform temperature distribution throughout the succeeding layer that mitigates development of thermally induced residual stress and thermal distortion related thereto in the 3D object during the additive printing process; and printing the succeeding layer using the thermal process onto the layer according to the second print sequence.

According to another nonlimiting aspect of the invention, a system is provided for monitoring and controlling a 3D printer that implements a layer-wise additive manufacturing process to form a 3D object made of multiple layers of print material. The system includes a thermographic imaging device for obtaining thermographic image data of a macro thermal field of individual layers of printed material formed by the 3D printer during the layer-wise additive manufacturing process, and a computer control module for controlling the 3D printer. The computer control module is configured to implement a control program comprising the steps: printing a layer of print material with the 3D printer across a print area according to a first print sequence of islands and/or stripes (obtained based on the geometry of the layer) using a thermal fusion process, wherein the layer comprises a plurality of melt areas of the print material; obtaining temperature distribution information for the layer across the entire print area using the thermographic imaging device; calculating a second print sequence of islands and/or stripes for printing an immediately succeeding layer of print material on the layer, wherein the second print sequence (obtained based on the temperature distribution of the layer and the geometry of the succeeding layer) is different than the first print sequence and is optimized to produce an optimal uniform temperature distribution throughout the succeeding layer that mitigates development of thermally induced residual stress and thermal distortion related thereto in the 3D object during the additive printing process; and printing the succeeding layer with the 3D printer using the thermal process onto the layer according to the second print sequence.

According to yet another nonlimiting aspect of the invention, a 3D printing system is provided for manufacturing 3D objects by additive manufacturing using a powder bed fusion process. The 3D printing system includes a 3D printer for implementing an additive manufacturing process to form a 3D object using a powder bed fusion process, a thermographic imaging device associated with the 3D printer for obtaining thermographic image data of a macro thermal field of individual layers of printed material formed by the 3D printer during the layer-wise additive manufacturing process, and a computer control module for controlling the 3D printer and configured to implement a control program that implements the method described above.

According to still another nonlimiting aspect, a set of computer instructions recorded on a non-transitory medium is provided. The set of computer instructions is configured to implement the method described above.

Technical aspects of systems and methods as described above preferably include the capability of providing improved homogeneous temperature distribution throughout a printed layer by optimizing the printing sequence of entities in island or stripe printing strategies, thereby increasing robustness through continuous quality checking in the earliest possible stage, which allows the prevention (or removal) of thermal defects through the implementation of corrective actions during the printing process itself, by modifying the printing sequence of the immediately succeeding layer. Furthermore, work leading to the invention provides new insights into the thermal evolution of the process, achieved through two parallel approaches. Firstly, it involves observing the variation in thermal distribution for different process parameters throughout the printing process, using the integrated layer-wise online monitoring and control modules. Secondly, it simulates thermal evolution across layers with different printing sequences by employing graph theory and utilizing a thermophysical-based model.

These and other aspects, arrangements, features, and/or technical effects will become apparent upon detailed inspection of the figures and the following description.

### BRIEF DESCRIPTION OF THE DRAWINGS

FIG. 1 schematically represents methodology for real-time and smart modification of printing sequences in different printing strategies in metal PBF printing process according to a nonlimiting embodiment of the invention.

FIG. 2 represents a nonlimiting example of an additive manufacturing system incorporating aspects of the invention.

FIG. 3 represents steps in a layer-by-layer thermography process that may be executed as part of the invention in some nonlimiting embodiments.

FIG. 4 is a flowchart of an algorithm for selecting a zone printing sequence in accordance with some nonlimiting aspects of the invention.

FIG. 5 represents an optimal printing sequence for a simple square consisting of nine islands calculated using some nonlimiting aspects of the invention.

### DETAILED DESCRIPTION OF THE INVENTION

The intended purpose of the following detailed description of the invention and the phraseology and terminology employed therein is to describe what is shown in the drawings, which include the depiction of and/or relate to one or more nonlimiting embodiments of the invention, and to describe certain but not all aspects of what is depicted in the drawings, including the embodiment(s) to which the drawings relate. The following detailed description also describes certain investigations relating to the embodiment(s) depicted in the drawings, and identifies certain but not all alternatives of the embodiment(s). As nonlimiting examples, the invention encompasses additional or alternative embodiments in which one or more features or aspects shown and/or described as part of a particular embodiment could be eliminated, and also encompasses additional or alternative embodiments that combine two or more features or aspects shown and/or described as part of different embodiments. Therefore, the appended claims, and not the detailed description, are intended to particularly point out subject matter that is regarded to be aspects of the invention, including certain but not necessarily all of the aspects and alternatives described in the detailed description.

Some of the drawings disclose certain dimensions or other aspects of various components that are believed to be preferred or exemplary, but are otherwise not necessarily limitations to the scope of the invention.

The system and method of the present invention are preferably intended to provide a more homogeneous temperature distribution (preferably the most homogeneous temperature distribution possible) throughout a printed layer by optimizing the printing sequence of entities in island or stripe printing strategies. As used herein, “optimize” and its various forms (including optimal) are intended to refer to a result of optimization, and the latter is used herein to refer to the attainment of significantly improved results though not necessarily the attainment of the best possible result. Optimization is done to harmonize the distribution of residual stress and minimize thermal distortion related thereto, a prominent thermal defect. This is achieved through an innovative integration of online (i.e., in real time without significant slowdown) thermography and an in situ closed-loop control algorithm. To accomplish this, an in-situ macro-field thermography was utilized that used an IR camera or near-IR camera to prioritize the data captured from the entire layer, processed data streams layer-by-layer, and provided thermal history of previously printed layers as feedback to the control system. The system and method are preferably capable of leveraging different mathematical thermophysical-based (MTB) models to compute a thermally related specification in order to optimize the printing sequence of islands or stripes layer-by-layer. The thermal feedback from the thermography system then calibrates or updates the thermal model layer-by-layer. Preferably, the system and method implement a computationally functional approach for real-time optimization of scanning topology in chessboard and stripe printing strategies, using one or more different MTB models.

The ability to utilize different MTB models is notable for demonstrating printing strategies and the ability of the system and method of the present invention to function with a range of mathematical or thermophysical-based models. Preferred MTB models perform computations in real-time. Even so, the system and method are not restricted to particular MTB models, including those discussed herein, for example, the development of more complex or accurate models is foreseeable.

The system and method of the present invention were successfully implemented with a computationally efficient thermophysical-based model or mathematical model based on underlying thermophysical concepts of a powder bed fusion (PBF) process of additive manufacturing in order to obtain a proper scanning parameter related to the printing sequence of islands or stripes. An objective is to generate a uniform temperature distribution through modification of the printing sequence of printing entities, and a proper scanning parameter must correlate between the printing sequence and thermal distribution throughout consecutive printing layers. Three different models including the tessellation algorithm, Genetic Algorithm Maximum Path (GAMP) strategy, and Graph Theory (GT) were developed to provide such correlation. The tessellation algorithm uses the distances between printing entities as the parameter to generate a uniform temperature distribution, the GAMP strategy uses the path that connects the geometrical center of printing entities as the parameter to generate a uniform temperature distribution, and Graph Theory computes the thermal distribution directly. It should be noted that each of these models is required to be calibrated layer-by-layer based on the thermal history of previously printed layers, geometrical features, and thermal boundary conditions of the current layer under fabrication, and the machine printing-related conditions. A layer-wise calibration technique was enabled through the model integration with the thermography module and using the feedback provided by a thermal sensor. The Tessellation algorithm extracts the printing sequence of the islands/stripes by calculating the distance of all non-printed islands with the formerly printed islands and each time selects the island with maximum minimum distance to the printed islands. This loop continues to select all the islands. The GAMP strategy applies the genetic algorithm to maximize the scanning path—the path that connects the centers of the islands/stripes—in each exposure zone.

In a non-limiting example, a monitoring and control system for 3D printing of a 3D object obtains a thermographic image data of a macro thermal field (temperature distribution throughout an entire layer or a printed zone larger than a single melt point) of a layer of printed material after the layer is printed and before an immediately succeeding layer of printed material is printed onto the layer, analyzes the thermographic image data using an MTB model, and defines a new printing sequence for the succeeding layer onto the layer based on the MTB model to provide an optimal homogeneous temperature distribution throughout the succeeding layer. Preferably, the system prints the 3D object using a PBF process. In some preferred arrangements, the system repeats the steps in a layer-wise manner (e.g., layer-by-layer) successively for all layers of the print material used to form the 3D object during the 3D printing process.

In another non-limiting example, a method of controlling a printing sequence in a 3D printer of an immediately succeeding layer of printed material onto a layer of printed material for creating a 3D object captures thermographic data of the layer, and then uses the thermographic data of the layer to calculate a new printing sequence of the succeeding layer using an MTB model to produce a uniform temperature distribution throughout the succeeding layer that mitigates thermally induced residual stress and thermal distortion related thereto in the 3D object. The printing sequence of zones and/or stripes calculated with the MTB model for each layer is optimized to maximize homogeneous temperature distribution across each layer, for example by minimizing temperature gradients across the layer. This typically results in the printing sequence of each layer being at least slightly different than a default printing sequence that would be implemented by default by the 3D printer or the printing sequence of the previous layer. Preferably, the method is repeated layer-by-layer (“layer-wise”) for all layers of printed material that form the 3D object formed by the 3D printer.

A significant concept of the system, components, and methods of the present invention is to provide a feasible and practical real-time, macro-scale thermography-based technique for additive manufacturing based on thermal fusing additive manufacturing techniques, such as the PBF process, and provide a corresponding module that can be seamlessly integrated with a closed-loop control system for an additive manufacturing system, such as a metal powder bed fusion 3D printer. In some nonlimiting embodiments, the resulting integrated system can be adapted to function with and/or mounted to any commercial metal PBF 3D printer with the ultimate objective of mitigating thermally induced residual stress and thermal distortion related thereto within the printed parts in real-time. To fulfill such an objective the present system provides an intelligent methodology to modify the printing sequence of islands or stripes in respective chessboard or stripe scanning strategies in real-time. This methodology produces or maintains a uniform thermal distribution in each printed layer. In some nonlimiting configurations, the system includes a layer-wise thermography-based module to monitor the thermal distribution throughout the last printed layer. This data is then fed into a mathematical thermophysical-based model to optimize a thermal-related parameter. The objective function for optimization is to generate the most uniform temperature distribution possible throughout the next layer by modifying the printing order of the islands or stripes in the next layer.

In some non-limiting examples, the implementation of the system and method involves the following steps. Step 1: perform layer-wise thermography of an entire layer after it was printed and before the spreading of powder for printing a new layer to obtain thermal feedback from the thermography technique. Step 2: develop a mathematical thermophysical model to utilize the thermal feedback from the thermography technique. Step 3: apply a modification/optimization technique to adjust/optimize a thermal-related parameter inside the developed mathematical thermophysical model with the objective of modifying the printing sequence of the islands or stripes (depending on the type of scanning strategy implemented) to generate a uniform temperature distribution throughout the next printed layer. Step 4: repeat steps 1 to 3 after printing each layer until completing the printing process for the 3D object being printed.

The system and method preferably are conducted in real time during the printing of the 3D object (“online”) to adjust the printing sequence of each successive layer based on the thermographic data from the previous layer without significantly reducing the amount of time between fusing successive layers of the 3D object. In order to accomplish this, an MTB model computed from the thermographic data of each layer is developed that reduces calculation time, reduces calculation resources, and yet provides accuracies near those of significantly slower known models. The mathematical thermophysical-based model preferably implements a graph theory (GT) solution with irregular node distribution for the “thermal conduction equation” that computes the absolute optimal printing sequence of islands based on thermal characteristics of printed powder, thermal history of the previously printed layer, and geometry of the next printed layer. The thermal data is preferably taken as a macro thermal field that includes the entire layer or a smaller zone within the entire layer having several individual melt areas so that the MTB encompasses the entire layer or similar macro thermal field. Preferably, the thermal data is obtained by taking a thermal image of a layer with several areas of melted print material, detecting, and classifying thermal zones within the thermal image of the layer, and then computing a measure of temperature uniformity and thermal plots in the layer.

The thermographic image data may be obtained with one or more thermal sensors, such as infrared cameras or near-infrared cameras, immediately after printing of the current layer and before spreading of printing material for printing the immediately succeeding layer. The printing material may include any material used in a thermal fusion printing process for additive manufacturing, such as a metal, a plastic, or a ceramic. The printing material is preferably in a powder form suitable for use in the powder bed fusion process.

A new beneficial aspect of the system and method in some nonlimiting aspects of the present invention includes the concept and technique of collecting the temperature distribution throughout each layer in a layer-by-layer fashion (by capturing the data after printing each layer and repeating this process), with the specific purpose of providing thermal data for feedback to a real-time control system. Another new beneficial aspect of the system and method in some nonlimiting aspects of the present invention includes employing a thermography-based technique to monitor and provide feedback from the macro thermal field to the control system in the laser powder bed fusion (LPBF) process. A further new beneficial aspect of the system and method in some nonlimiting aspects of the present invention includes using this feedback to modify the printing sequence of the islands and/or stripes of each successive print layer.

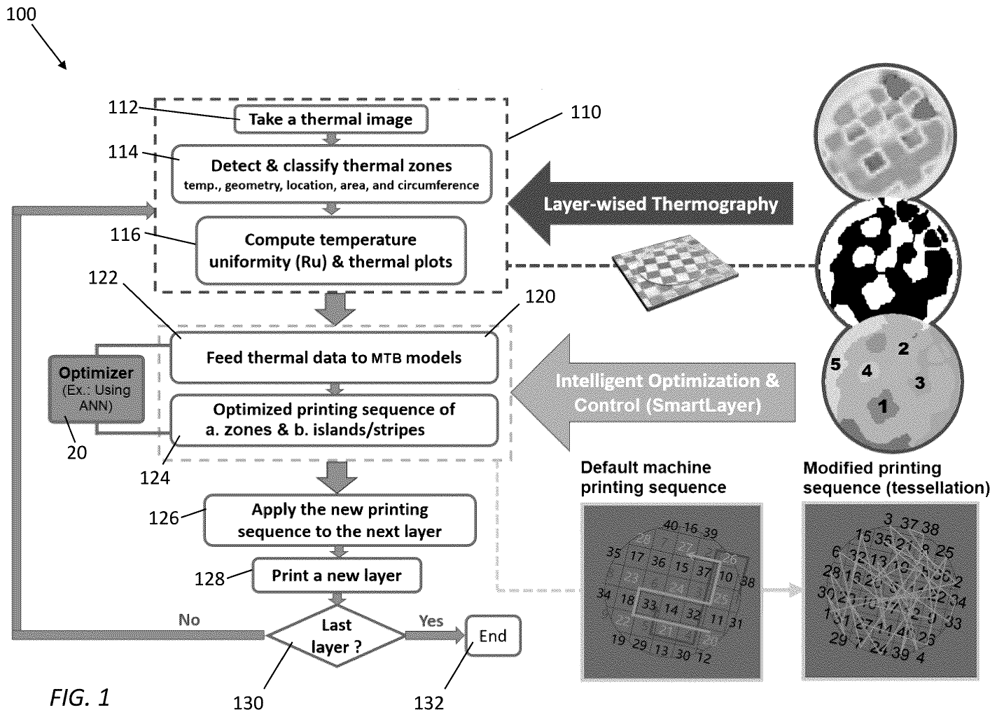

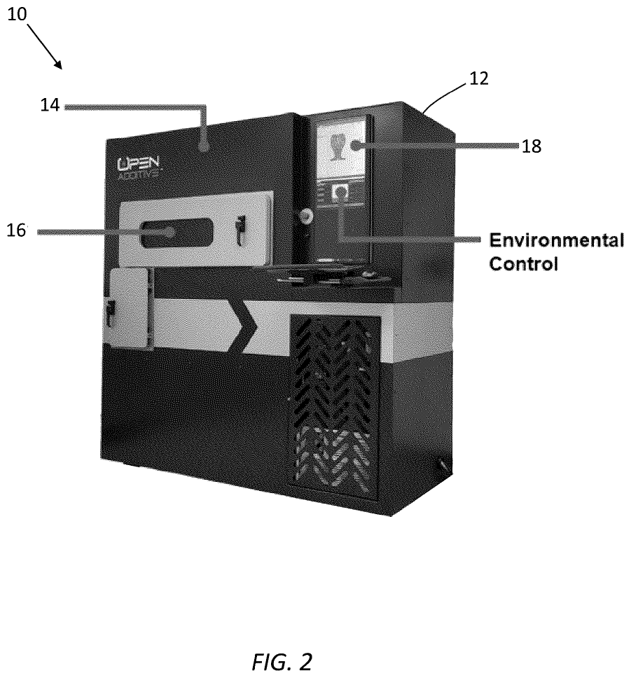

As seen in FIG. 1, a method 100 implemented by an intelligent online thermography and a closed-loop control system according to some nonlimiting aspects of the invention is configured to optimize the printing sequence of islands and stripes during the process of additive manufacturing with a thermographic process on a 3D printer by secking the most uniform possible temperature distribution obtainable from chessboard and stripe scanning strategies. Preferably, the method 100 is implemented by a system 10 (FIG. 2) on a 3D printing machine 12 outfitted with a thermography module 14, for example including a thermographic imaging device, configured to obtain macro-scale thermographic image data of each entire layer of a printed material inside a build chamber 16 in the time period between the printing of each successive layer of print material. The 3D printing machine 12 can be any printing machine suitably configured for creating 3D objects by additive manufacturing of multiple layers of print material using a thermographic process. Preferably, the 3D printing machine 12 includes and/or is controlled by a computer control unit 18 implementing hardware and/or software to control creation of the layers using a PBF process (e.g., laser sintering of powder print material, such as metal, plastic, and/or ceramic) based on a mathematical model of the 3D object, such as a CAD model, for example, by implementing chessboard and/or stripe scanning strategies for printing. The thermography module 14 preferably includes an infrared camera or near-infrared camera, but other types of thermographic imaging devices could be used.

With reference again to FIG. 1, because uniform temperature distribution contributes to homogenous distribution of thermal residual stress and thus mitigates the thermally related distortion, the method 100 executed by the system 10 executes three primary steps 110, 120, and 130 to attain an optimal uniform temperature distribution. In step 110, the system 10 executes a layer-wise thermography and data analysis process. Real-time thermography is the preliminary task to obtain information on the thermal history and thermally induced anomalies in PBF such as temperature gradient and overheated zones throughout a printed layer. These anomalies may occur due to uneven powder distribution, lack of support structure, etc. The thermography module 14 allows the MTB models to calibrate or update the thermal characterization of the model after printing a new layer. In this step, thermal sensors, such as infrared or near-infrared cameras, are used to capture thermal data immediately after printing the current layer and prior to the powder spreading for printing the immediately succeeding layer. In one nonlimiting embodiment, the system 10 automatically collects thermal data from the layer and employs segmentation image processing algorithm in MATLAB® to analyze data and repeat this process layer-by-layer. The system 10 and method 100 employ a layer-wise thermography methodology combined with the control unit 18 to modify the printing sequence of islands or stripes, layer-by-layer. The thermography module 14 leverages the interface between commercial IR thermography software such as FLIR ResearchIR Max® software or Xeneth® and MATLAB® to implement a smart measurement planning method ensuring an efficient, practical, and responsive system with real-time feedback to the designed control strategy.

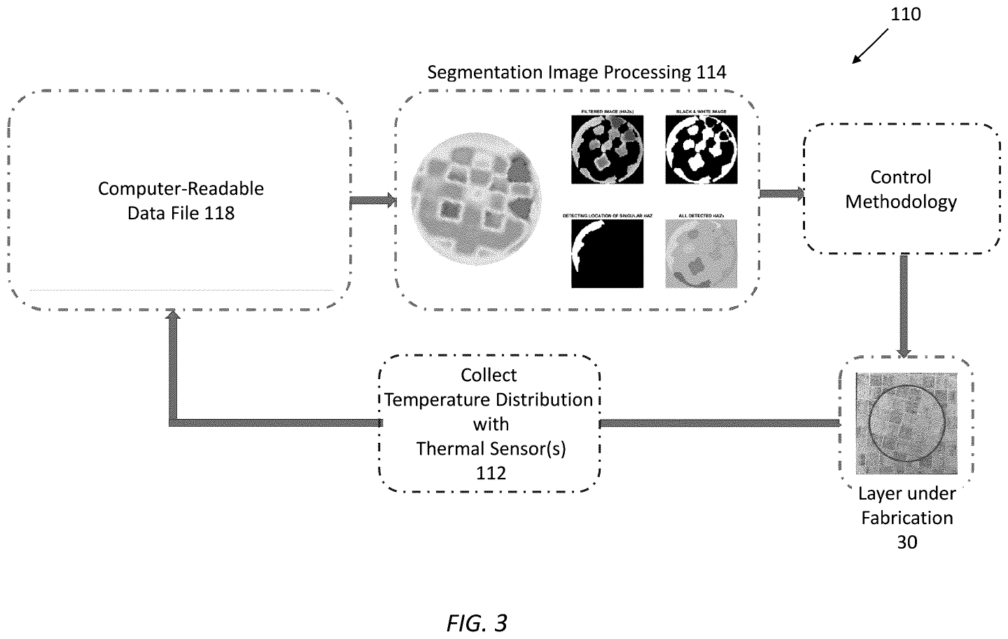

In step 110, the thermography module 14 takes a series of steps to evaluate thermal evolution of the process, layer-by-layer. FIG. 3 illustrates a nonlimiting embodiment of these steps. At 112 the temperature distribution of the printed layer is automatically collected immediately after printing (fabricating) the current layer 30 and before spreading powder for the upcoming layer. To perform step 112, the IR camera is activated either through software or by using a physical trigger switch, implemented by or on the control unit 18 to record the temperature distribution throughout the current layer 30 for a short duration with no dropped frame, just before the layer 30 is completely printed. The last frame immediately after completion of the printing of the layer 30 is used for collecting both thermal distribution and geometrical data of the printed zones. The layer-wise thermal data collected at 112 in some non-limiting embodiments is stored in a computer readable data file 118, such as an ASCII file or other type of computer-readable data file. In step 114, the thermal data collected and stored in the data file 118 is used to identify and analyze macro scale heat affected zones (“HAZs,” also referred to simply as “zones”) in the layer 30. The thermal images captured by the thermography module 14 show that each layer consists of different HAZs, each with a distinct temperature and an irregular geometry with a certain number of islands or stripes. The macro scale HAZs and the thermal and geometrical related specifications of the HAZs are detected because the ultimate temperature distribution of the printed layer 30 is the consequence of thermal interaction between these zones. Moreover, controlling the thermal features of these zones can hinder initiation of some prevalent thermal anomalies, such as balling phenomena, undesired melting, and inhomogeneous microstructure. In one nonlimiting configuration, step 114 first applies a thermal filter, for example, in IR-Max software called palette, to generate a bicolor thermal image that distinguishes the area above the threshold temperature. Then, an image segmentation algorithm, for example developed in MATLAB, is used to detect HAZs using a selected threshold value. The algorithm uses the threshold to change the representation of the thermal image into a set of segments that collectively cover the entire image. Each of the pixels in a region are similar with respect to some characteristic or computed property, such as color, intensity, or texture. Adjacent regions are represented with significantly different colors with respect to the same characteristic(s). The image segmentation algorithm used at step 114 saves the allocated pixels to each zone to measure the geometrical center, area, circumferences, and the distance of the center of each zone with respect to other zones. The control methodology uses this data in different thermophysical models to modify the printing sequence of islands or stripes for the next printed layer as discussed hereinafter. Step 116 within the sequence of step 110 is to assess the uniformity of distributed temperature. The algorithm calculates the ratio of temperature uniformity and the average temperature for the printed layer. In one non-limiting embodiment, the average temperature is computed as the mean of all the pixels' temperature within a detected zone as captured by the IR camera. The measure of uniformity in each layer is a thermal characteristic that is used later as the objective function in an optimization method discussed hereinafter. The measure of uniformity enables the control unit 18 to minimize the temperature gradient throughout each layer under fabrication and between consecutive fabricated layers. A nonlimiting technique of measuring temperature uniformity is to use Equation 1, which is a ratio (Ru) where T and T represent the local temperature and average temperature, respectively.

$${R}_{u} = {( \sum {( \frac{T - \overline{T}}{\overline{T}} )}^{2} )}^{\frac{1}{2}} \qquad ( Eq . 1 )$$

Next at step 120, the printing sequence of zones and islands and/or stripes for the next layer to be printed is optimized using one or more MTB models. To accomplish this, at 122, the system 10 feeds the thermal data collected in the step 110 to an MTB model developed to compute a thermally related process parameter in order to intelligently optimize the printing sequence of islands or stripes layer-by-layer. In this nonlimiting example, the optimization objective is to generate the utmost uniform temperature distribution across the entire printed layer, and optionally also across stacked layers. Thereafter at 124, an optimizer module 20 optimizes the scanning strategy for the next layer based on the MTB model(s).

The first step in optimizing the scanning strategy for the next layer is to select the best sequence to print the thermal zones (HAZs) since the thermal interaction between these zones is a dominant factor for the ultimate temperature distribution of the printed layer. In one nonlimiting embodiment, the system 10 and method 100 use the thermal images from the last printed layer to determine the geometrical and thermal specifications of the HAZs in that layer and determine the printing sequence of the zones. This strategy first prints the zones with either a lower average temperature or with less heat dissipation to facilitate heat dissipation throughout the layer, mitigate heat accumulation in the zones, and generate a more uniform temperature distribution throughout the current layer. In the development of the invention several factors were observed and/or identified as contributing to the thermal development of a layer. The heat dissipates more rapidly within the printed zones with smaller areas or narrower geometry compared with zones with larger area or wider geometry. In the context of this observation, a narrow geometry (vs. wide geometry) here is defined as a geometry with relatively large circumference to area ratio. The cooling rate is higher at the boundaries of the printed zones compared with their geometric centers. The printed zones with symmetrical shapes and boundary conditions which are symmetrically arranged throughout the printed layer, generate a symmetrical temperature distribution. The temperature contour shows the heat accumulated around the geometrical center of the printed zones. On the other hand, in the regions with non-symmetrical geometry or boundary conditions, the temperature contours roughly follow the regions' geometry. The printed zones with large areas (relative to the entire area of the layer) significantly affect the thermal distribution of the entire layer; on the other hand, in the printed zones with small or medium size zones, the temperature distribution depends on the distances between the zones. Small, printed zones only affect the temperature distribution locally if the distance between them is large enough. The distance between the printed zones and layer edges significantly affects the cooling rate. The longer the distance to the edge, the higher the cooling rate. The number and positions of the printed zones affect the temperature distribution. The temperature accumulates within the area with a higher number of printed zones. This increases the temperature gradient between the area and its adjacent areas and, consequently, increases the cooling rate. The ratio of the circumference to the area of a printed zone (defined as Rea, the effect of convex geometry versus concave geometry) affects the temperature distribution and cooling rate. The zones with convex geometries show higher heat accumulation particularly around the geometric center of the zone while the zones with concave geometries show a higher cooling rate due to a relatively larger Rca value. Using more support structures with smaller diameters increases inter-layers heat dissipation compared to less support structures with larger diameters; no influence on the temperature distribution pattern was observed. Based on these various observed factors, the system 10 determines the printing sequence of the zones by applying one or more of the following rules: consider small neighbor zones as one integrated region; print hanging zones with lower number of supports earlier; print larger zones earlier; if some zones have same area size, print the zones with smaller Rea earlier (wider geometries are printed before the narrower geometries); print the zones closer to the edge of the printing layer earlier; and print the zone with farthest distance from the prior printed zones earlier.

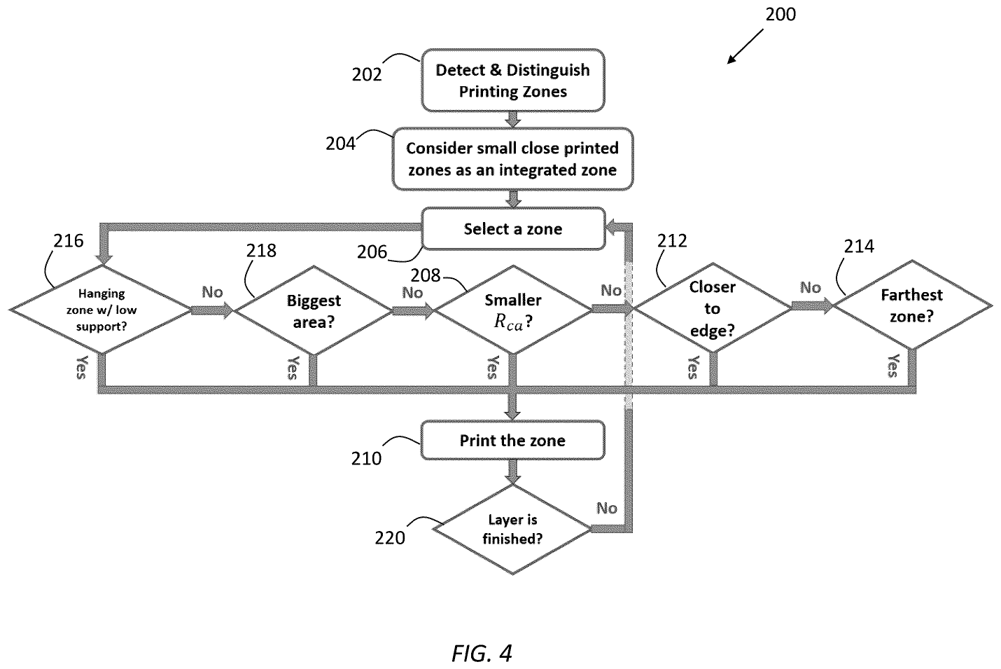

FIG. 4 represents one nonlimiting example of an algorithm 200 for determining a more efficient and preferably the most efficient print sequence of the zones in the next layer based on the rules developed by the observations. The algorithm 200 may be referred to as a “smart” algorithm or described as implementing “smart” steps or a “smart” process for modifying the printing sequence consistent with the contemporary use of the term “smart manufacturing” to refer to the use of advanced technology, data, and automation to improve manufacturing processes and make them more efficient, flexible, and responsive. In the smart algorithm 200, at 202, printing zones are detected and distinguished. Next at 204, small close printed zones are considered as an integrated zone. Then at 206, a zone is first selected and the zone is processed through a logic tree implementing the rules. At 208, it is determined if the zone has smaller Rea compared with other non-printed zones. If yes, then at 210 that zone is selected to be printed next in the print sequence, else at 212 it is determined if the zone is closer to the edge. If yes, then at 210 that zone is printed is selected to be printed next in the print sequence, else at 214 it is determined if the zone is farthest from the edge. If yes, then at 210 that zone is printed is selected to be printed next in the print sequence, else at 216 it is determined if the zone is a hanging zone with a lower number of supports than other zones. If yes, then at 210 that zone is printed is selected to be printed next in the print sequence, else at 218 it is determined if the zone has the largest area Rea. If yes, then at 210 that zone is printed is selected to be printed next in the print sequence, else the algorithm returns to 208. After any instance in which the zone is selected to be printed at 210 next in the printing, at 220 it is determined if the entire layer is complete with the selection of that zone. If yes, then the printing sequence of zones for that layer is finished and the algorithm ends for that layer, else, the algorithm returns to 206 to select another zone, and the logic tree is repeated for that zone until all the zones have been placed smartly in a printing sequence.

Referring again to FIG. 1, after the best sequence for printing the zones has been defined, at 124 the second step in optimizing the scanning strategy for the next layer is to optimize the printing sequence of the islands and/or stripes within each zone with respect to that zone's geometrical and thermal features in order to generate the utmost uniform temperature distribution within each zone. Preferably, an accurate thermophysical-based model that allows real-time computation of thermal distribution is implemented to optimize the printing sequence of the islands and/or stripes within each zone. The thermophysical-based model is integrated with an optimization algorithm to generate a fully optimized (optimal) printing sequence. Such a fully optimized printing sequence preferably uses the thermophysical model to compute thermal distribution throughout the printed layer or part rapidly and precisely. The optimization algorithm can leverage the thermophysical-based model capabilities of considering the geometry of printing area, generating uniform temperature distribution, and avoiding heat accumulation during printing process while overcoming the inability of other models in considering thermal interaction between exposure zones during printing process. Furthermore, a thermophysical-based model that enables the obtainment of a fully optimized printing sequence can be used as a benchmark performance to compare the computational efficiency of different optimization algorithms and the effectiveness of the models in minimizing temperature gradients across a printed layer, between the approaches that enable the obtainment of a semi-optimal printing sequence and the approaches that enable the attainment of a fully optimized printing sequence. Also, this comprehensive thermophysical-based model can form the basis for rapid process simulation, as well as synthesis with analytical models for the prediction of prevalent thermal abnormalities such as residual stress and the thermal distortion related thereto.

A preferred thermophysical-based model for use by the optimizer module 20 in optimizing the scanning strategy for the next print layer at 124 is a generalized graph theory (GT) model. Compared with other models, the GT model is preferred for real-time application in a 3D printing process because the GT model runs substantially faster and generates more precise results for the same number of nodes within a model of the print layer. However, other thermophysical-based models could be used, such as Finite Element Analysis (FEA) or Finite Differences Method (FDM) or mathematical thermophysical-based models such as a tessellation algorithm or genetic algorithm maximum path (GAMP) strategy.

The GT model is a thermophysical-based model that computes the absolute optimal printing sequence of islands based on thermal characteristics of printed powder, thermal history of previously printed layer, process parameters, and geometry of printed layer. To perform this step without compromising the fabrication time of the 3D printing process, the time for determining the printing sequence of islands or stripes (sequence time) is preferably limited to the blade paved time period, i.e., the time elapsed when the machine's blade distributes the powder over the built bed for printing the new layer. This measured time is typically less than 30 seconds. One viable approach to expedite the sequence time is to use mathematical thermophysical-based models to find a semi-optimal printing sequence of the islands or stripes. These heuristics models are derived from the thermophysical rudiments of conductive metal material in PBF and modify process parameters to generate a more uniform temperature distribution throughout the printed layer. GT models have the benefit of using unstructured grids (irregular mesh) for freeform geometrical shapes of layers with intricate details, which expedites the computational process and preserves the solution accuracy as well as reducing the order of the governing equation by reducing the number of nodes needed for solving the function, thereby reducing the computational cost compared to alternative approaches, such as finite element analysis or finite difference method.

Despite these superior features of the GT method over traditional approaches for solving thermal equations, it still suffers from a fundamental drawback: the graph-theoretic solution only solves the homogenous version of the governing thermal conduction equation. The computational accuracy of the solution decreases for processes such as PBF characterized by rapid thermal diffusivity when the model dimensions are increased because the homogeneous solution eliminates the thermal load (laser source) and substitutes it with the resulting post-printed temperature as initial condition. Therefore, the equation starts diffusing heat after a selected zone is printed and neglects the thermal dissipation throughout the part during printing process. Although the printing time of a small zone (such as one island or portion of an island) is very short due to the very high-speed laser movement (˜1200 mm/sec), the cooling rate is extremely high in metal PBF process as well. The very high cooling rate makes this simplification impactful in terms of computational accuracy in parts with large dimensions. To resolve this issue, a general solution to the thermal conduction equation was derived. This general solution is fully compatible with real-time computational thermal analysis while preserving the computational and load resolution for other applications.

In this embodiment, the GT model provides a solution to the thermal conduction equation (Eq. 2). The GT model offers the homogeneous solution (Tₕ) to the thermal conduction equation, effectively diffusing heat during the printing process by applying the thermal load directly.

$$( \frac{{\partial }^{2}}{\partial {x}^{2}} + \frac{{\partial }^{2}}{\partial {y}^{2}} + \frac{{\partial }^{2}}{\partial {z}^{2}} ) T + \frac{\dot{q}}{k} = \frac{1}{α} \times \frac{\partial T}{\partial t} . \qquad ( Eq . 2 )$$

This modified GT model provides both the particular solution (Tp) of Equation 3 and the homogenous solution (Tₕ) for the non-homogenous thermal conduction equation (Eq. 2) using GT. This extension diffuses heat during printing process by applying the thermal load directly.

$$T ( t ) = {T}_{h} ( t ) = {e}^{A ( t - t 0 )} T ( {t}_{0} ) \qquad ( Eq . 3 )$$

Additional aspects can be appreciated from US 2022/0114307 to Severson et al., whose contents are incorporated herein by reference.

The optimization process 120 is the last step to successfully deploy the closed loop real-time monitoring and control system of the present invention. The optimization process is performed by the optimizer module 20, such as a computer program implemented and/or accessed by the control unit 18. The optimizer module 20 is preferably merged with the developed MTB models efficiently. The objective of the optimization process is to find the island or strip printing sequence in island or strip scanning strategy in such way to generate the utmost uniform temperature distribution for any freeform geometry when the 3D printing machine 12 prints the new layer. The optimization algorithm uses the thermal image of the last printed layer just after it is printed. Based on the data acquired, the optimization algorithm provides the optimal printing sequence of the zones and islands or stripes within each zone for the upcoming layer. This optimization process is repeated after printing each layer until the part is completed. The constraint is to optimize the printing sequence withing the blade paving time (around 30 sec).

Selecting the optimal printing sequence is a combinatorial problem with non-repetitive variables. One way to address this problem is to use a gradient-free approach such as a genetic algorithm (GA). Some advantages of such an approach include fast solution and adjustable accuracy (error percentage), while a disadvantage is a non-deterministic solution. The genetic algorithm helps in finding global optimization rapidly while searching in a large dataset. Due to its probabilistic and stochastic nature, genetic algorithms can work well for multi-modal problems (problems with multiple locally optimal solutions).

Given the constraint of limiting optimization time to a blade's brief paving window and the inherent complexity of the optimization problem's large dimensions, machine learning facilitates real-time closed-loop feedback control within PBF processes. For this purpose, Convolution Neural Networks (CNN) can be used, specifically, a supervised Artificial Neural Network (ANN) technique that was tailored for handling signal inputs such as images, similar with the data collected by the thermography module. This technique promoted the ability to manage the problem's vast dimensions. For instance, when training a function on image inputs, each pixel functions as an input. Consequently, a single image with an 8K resolution (7680×4320 pixels) encompasses a staggering 33,177,600 input data points. To address this, CNN employs various operations that effectively reduce these extensive dimensions and analyze the data.

Selecting the printing sequence as an output parameter and the geometry and thermal distribution of each printing layer as inputs, CNN can be used to train a function to provide a modified printing sequence to achieve a uniform temperature distribution for a desired geometry with distanced thermal conditions. The dimensions of a standard 3D printing machine's build bed measure 152.4×152.4 mm². With an island side size set at 5 mm, the number of feasible combinations to print the largest possible layer using the island scanning strategy is an astounding 900. Likewise, for the strip scanning strategy, assuming a width of 5 mm for each stripe and a length of 152.4 mm for each stripe, this number is 31. A systematic approach was designed to generate a comprehensive array of geometries, ensuring the coverage of a diverse range of potential configurations for layer printing. This is financially feasible since the data set is generated by leveraging graph theory combined with optimization algorithms to provide the optimal solution to each training point. Though a particular ANN algorithm or optimization methodology can be utilized, the development of more complex or accurate models is foreseeable.

To observe the dynamics of a thermal optimization process in the smart printing sequence of islands in accordance with some nonlimiting aspects of the invention, the optimization process was simulated for a simple 2D 15×15 mm² layer consisting of nine islands. A primary graph theory algorithm developed for 2D planes was used and with simple thermal loading (homogenous loading applied on an entire island or stripe) to compute temperature distribution throughout the plane, synchronized by the genetic algorithm to find the optimal printing sequence. In a case study, the variables were discrete numbers, i.e., the number assigned to islands or stripes since the objective was to find the printing sequence of these printing entities. The fitness function was the uniformity coefficient (Eq. 1) for each printed zone. To be more precise, the selection criterion is to select the printing sequence which provides the highest temperature uniformity (minimizing uniformity coefficient in Eq. 1). The algorithm computed the uniformity coefficient for different island printing sequences. Nine islands were used in the primary experiment, and therefore the following GA parameters were defined: lower bound (lb) was (1, 1, 1, 1, 1, 1, 1, 1, 1) and the upper bound (up) was (9, 9, 9, 9, 9, 9, 9, 9, 9). No linear equalities or inequalities as boundary conditions or minimization constraints were applied in the genetic algorithm. IntCon was defined as (1, 2, 3, 4, 5, 6, 7, 8, 9) representing combinatorial problem with integer variables in the genetic algorithm. Moreover, the maximum number of generations (“MaxGenerations”) was set on 500 with the population size (“PopulationSize”) of 500 and “EliteCount” equals as 0.1×PopulationSize represented the number of individuals guaranteed to survive to the next generation.

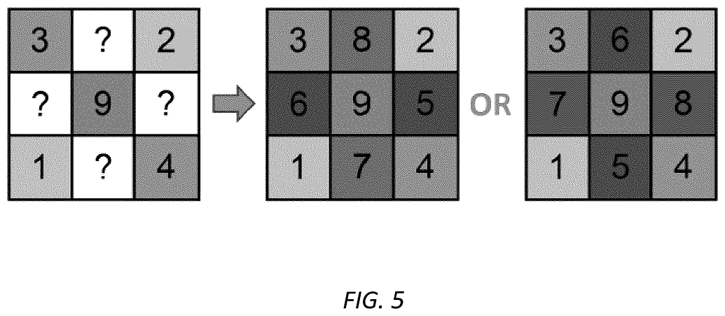

The results in terms of computational time and accuracy were promising. The optimization process for 5041 nodes takes around 21 seconds in total. This time includes the time for computation of temperature distribution for the selected printing sequence by the genetic algorithm in each iteration (around 0.3 seconds). This is while traditional gradient-based approaches such as linear programming take around 12 minutes to find a deterministic solution for 100 nodes in 1D case of study. Because the genetic algorithm is a non-deterministic approach, the solution to the genetic algorithm is not unique; however, the genetic algorithm finds the solution close to the best fitness function in each run (within around 5% error). It was observed that in this case the optimal printing sequence follows a similar trend in each run (see FIG. 5). First, the optimization process starts with one corner, then print the opposite corner. Next, it goes to the other corner and then, it prints the opposite corner. Next, it prints the islands placed between the corners on opposite sides. Finally, it prints the central island.

The best fitness function values obtained after running the code several times were 4.6788 and 4.6768, which were obtained for two different sequences, shown in the middle and right sections of FIG. 5, respectively. As illustrated in FIG. 5, another promising observation was the presence of a symmetrical printing sequence trend, which aligns with expectations regarding the relationship between thermal gradient and thermal distortion. The results show that the optimization algorithm minimizes the cost function consistently, it takes 21 sec to optimize a problem with only 9 variables (e.g., a plate consisting of only 9 islands or stripes).

Of course, after the optimal printing sequence is calculated by the optimizer in the step 120, at 126 the new (optimal) printing sequence is applied to the next print layer to define the printing sequence of the next print layer, and at 128, the next print layer is printed according to the new optimal printing sequence obtained at 120. As represented schematically in the lower right corner of FIG. 1, it can be seen that the new optimal printing sequence is modified from the default machine printing sequence. Often, the new optimal printing sequence for the next print layer will also be different than the optimal printing sequence for the immediately prior print layer.

In step 130, the process 100 is repeated layer-by-layer until completion of the 3D printing process. As a nonlimiting example, at 130 the control module determines whether the printer layer that was just printed at 128 is the last layer of the 3D object. If no, then the process 100 returns to step 110 and is repeated for the next layer. Else, when the last layer of the 3D object has been printed, the process 100 ends at 132. In this way, the first, second, and third primary steps 110, 120, and 130 are repeated sequentially, layer-by-layer until completion of the 3D object.

Preferably, these optimization algorithms are integrated with existing 3D printing technology. In one nonlimiting example, the optimization algorithms are integrated into an open architecture 3D printing machine by embedding code into the DMC® software that controls the machine. The implementation of these algorithms is believed to result in 3D printed parts with more balanced residual thermal stress, thereby reducing thermally induced distortions. Successfully completing this step will significantly decrease the failure rate of part production, shorten lead time considerably, and allow fabrication of parts with larger dimensions and more complex geometries but lower defects.

Furthermore, the present invention in some nonlimiting embodiments may provide a precise and universal data-driven physics-based model that computes thermal distribution throughout a fabricated part with freeform geometry and any desired material in real-time without slowing down the printing time (e.g., the blade paved time period). This model is preferably integrated with a thermography module so that it is capable of being calibrated as needed during the process and can simulate the temperature evolution in machines with different specifications and printing conditions.

In view of the above, it can be seen that the online thermography and closed-loop hybrid-control system of the invention in some nonlimiting embodiments provides an intelligent approach to optimize the printing sequence of islands or stripes in PBF. The system is based on using IR thermography to detect heat affected zones layer-by-layer (a key thermal process signature) on a macro scale level. The system synchronizes with different mathematical (as nonlimiting examples, Tessellation algorithm and GAMP strategy) or thermophysical models (as nonlimiting examples, FEA and FDM) to optimize island or stripe printing sequence and generate a uniform temperature distribution in each heat affected zone as well as throughout the entire layer. Furthermore, the models study the fundamental relationship between significant process parameters and thermal distribution throughout a layer under printing.

The terms “smart” and “intelligent” are used herein consistent with their use in reference to current manufacturing approaches that use advanced technology, data, and automation to improve manufacturing processes and make them more efficient, flexible, and responsive. The modification of printing sequences as described herein can be viewed as a smart or intelligent process for several reasons: vast amounts of data are collected and analyzed through the thermography module throughout the manufacturing process to make data-driven decisions and improve efficiency; automated systems handle the printing process, increasing precision, and reducing human labor; the physics-based model based on Graph Theory combined with the thermography module creates a digital representation of the printing process to simulate, monitor, and optimize the printing operations; artificial intelligence (AI) and machine learning: are used to predict an optimal printing sequence (enhance decision-making for printing sequence); and a flexible scanning strategy (flexible printing sequence) based on the thermal characteristics/evolution of the process and geometrical aspects of the layer under printing that takes into consideration the thermal evolution or geometrical features of the printing layers.

As previously noted above, though the foregoing detailed description describes certain aspects of one or more particular embodiments of the invention, alternatives could be adopted by one skilled in the art. For example, the systems, methods, software, and their components could differ in appearance and construction from the embodiments described herein and shown in the drawings, functions of certain components of the systems, methods, software could be performed by components of different construction but capable of a similar (though not necessarily equivalent) function, and various materials could be used in the fabrication of the systems, methods, software and/or their components. As such, and again as was previously noted, it should be understood that the invention is not necessarily limited to any particular embodiment described herein or illustrated in the drawings.

1. A method of controlling an additive printing process implemented by a 3D printer in manufacturing a 3D object from multiple layers of print material, the method comprising:
printing a layer of print material across a print area according to a first print sequence of islands and/or stripes using a thermal fusion process, wherein the layer comprises a plurality of melt areas of the print material;
obtaining temperature distribution information for the layer across the entire print area;
calculating a second print sequence of islands and/or stripes based on the temperature distribution information for printing an immediately succeeding layer of print material on the layer, wherein the second print sequence is optimized based on the temperature distribution information to produce an optimal uniform temperature distribution throughout the immediately succeeding layer that mitigates development of thermally induced residual stress and thermal distortion related thereto in the 3D object during the additive printing process; and
printing the immediately succeeding layer using the thermal process onto the layer according to the second print sequence.

2. The method of claim 1, further comprising spreading printing material onto the layer for forming of the succeeding layer by means of a fusion process, wherein the step of obtaining is performed during the step of spreading.

3. The method of claim 1, further comprising:
obtaining temperature distribution information for the succeeding layer across the entire print area;
calculating a third print sequence of islands and/or stripes for printing a third layer of print material on the succeeding layer, wherein the third print sequence is different than each of the first and second print sequences and is optimized to produce an optimal uniform temperature distribution throughout the third layer that mitigates development of thermally induced residual stress and thermal distortion related thereto in the 3D object during the additive printing process; and
printing the third layer using the thermal process onto the succeeding layer according to the third print sequence.

4. The method of claim 1, wherein the obtaining and calculating steps are accomplished in real time during additive printing process between printing the layer and the succeeding layer, preferably in less than about 60 seconds, and more preferably less than 30 seconds.

5. The method of claim 1, wherein the step of obtaining temperature distribution information includes obtaining thermographic image data of a macro thermal field of the layer, preferably using at least one of an infrared camera and a near-infrared camera.

6. The method of claim 5, wherein the step of calculating comprises analyzing the temperature distribution information using a mathematical thermophysical-based (MTB) model that predicts the temperature distribution throughout the second layer, and the MTB model computes the temperature distribution for the second print sequence of islands and/or stripes based on thermal characteristics of the print material, temperature distribution of the first layer, and geometry of the second layer.

7. The method of claim 6, further comprising using the thermographic image data to calibrate/update the MTB model.

8. The method of claim 6, further comprising integrating the MTB model with an optimizer module to compute an absolute optimal printing sequence of islands and/or stripes for the upcoming layer based on thermal distribution of the current layer, and geometry of the upcoming layer.

9. The method of claim 1, wherein the additive printing process comprises a powder bed fusion process.

10. The method of claim 1, wherein the print material comprises at least one of a metal, a plastic, and a ceramic.

11. A system for monitoring and controlling a 3D printer that implements a layer-wise additive manufacturing process to form a 3D object made of multiple layers of print material, the system comprising:
a thermographic imaging device for obtaining thermographic image data of a macro thermal field of individual layers of printed material formed by the 3D printer during the layer-wise additive manufacturing process; and
a computer control module for controlling the 3D printer, the computer control module configured to implement a control program comprising the steps:
using a developed mathematical thermophysical-based model to print a layer of print material with the 3D printer across a print area according to a first print sequence of islands and/or stripes that uses a thermal fusion process based on layer geometry, wherein the layer comprises a plurality of melt areas of the print material;
obtaining temperature distribution information for the layer across the entire print area using the thermographic imaging device;
calculating a second print sequence of islands and/or stripes based on the geometry of current layer and the thermal distribution of previously printed layer) for printing an immediately succeeding layer of print material on the layer, wherein the second print sequence is different than the first print sequence and is optimized to produce an optimal uniform temperature distribution throughout the succeeding layer that mitigates development of thermally induced residual stress and thermal distortion related thereto in the 3D object during the additive printing process; and
printing the succeeding layer with the 3D printer using the thermal process onto the layer according to the second print sequence.

12. The system of claim 11, wherein the thermographic imaging device comprises at least one of an infrared camera and a near-infrared camera.

13. The system of claim 12, wherein the thermal process comprises a powder bed fusion process.

14. A 3D printing system for manufacturing 3D objects by additive manufacturing using a powder bed fusion process, the 3D printing system comprising:
a 3D printer for implementing an additive manufacturing process to form a 3D object using a powder bed fusion process;
a thermographic imaging device associated with the 3D printer for obtaining thermographic image data of a macro thermal field of individual layers of printed material formed by the 3D printer during the layer-wise additive manufacturing process; and
a computer control module for controlling the 3D printer, the computer control module configured to implement a control program comprising the method recited in claim 1.

15. A set of computer instructions recorded on a non-transitory medium configured to implement the method recited in claim 1.
